(19) United States
(12) Patent Application Publication
(10) Pub. No.: US 2012/0171652 A1
(43) Pub. Date: Jul. 5, 2012

(54) Pressure Ulcer Simulator and Related Methods

(76) Inventors: Jessica L. Sparks, Pilot Mountain, NC (US); Phillip Albert Sanger, Franklin, NC (US); Teresa Conner-Kerr, Gibsonville, NC (US)

(21) Appl. No.: 13/327,101

(22) Filed: Dec. 15, 2011

Related U.S. Application Data
(60) Provisional application No. 61/423,310, filed on Dec. 15, 2010.

(51) Int. Cl. G09B 23/28

(52) U.S. Cl. 434/262

(57) ABSTRACT

A pressure ulcer simulator for training medical practitioners includes a simulator model comprising one or more layers of simulated tissue. A plurality of pressure sensors are in communication with the one or more layers of simulated tissue and are configured to generate a pressure value sensed from one or more locations of the one or more layers of simulated tissue. A sensor system is in communication with the plurality of pressure sensors and is configured to receive the pressure values from one or more locations of the one or more layers of simulated tissue and to generate a risk value of developing a pressure ulcer for the one or more locations of the one or more layers of simulated tissue.

### RELATED APPLICATIONS

This application claims priority to U.S. Provisional Application Ser. No. 61/423,310, filed Dec. 15, 2010, the disclosure of which is hereby incorporated by reference in its entirety.

### GOVERNMENT SUPPORT

This invention was made with government support under grants from the Department of Education (Title III grant number P031B085015). The government has certain rights to this invention.

### FIELD OF THE INVENTION

The present invention relates to medical training simulators, and in particular, simulators for training medical professionals to reduce a risk of pressure ulcers.

### BACKGROUND

Pressure ulcers are common complications in patients who are confined to beds or wheelchairs. Pressure ulcers occur when soft tissue is compressed between a bony eminence, such as the greater trochanter, and the bed or wheelchair. Comatose, paraplegic, or debilitated patients have difficulty sensing discomfort caused by pressure from prolonged contact with hard surfaces and may not move or be moved frequently enough to relieve the compressed soft tissue. This condition impairs the quality of life for many, especially the elderly. It is estimated that pressure ulcers also impart a $1.2 billion annual burden to the U.S. healthcare system, in part due to the complexity of identifying, treating and managing pressure ulcers.

In the education of healthcare professionals, patient simulators have been used to recreate medical scenarios in which practitioners work on “life-like” patient models that may simulate physiological responses such as eye movement, heart rate and blood pressure. Guided by these responses, trainees execute medical interventions in the form of drug administration, surgical procedures and other techniques. This type of simulation-based training promotes critical thinking, timely decision making, clinical skills and communication among peers as well as patients. However, patient simulators have generally not addressed pressure ulcer management and prevention.

### SUMMARY OF EMBODIMENTS OF THE INVENTION

According to some embodiments, a pressure ulcer simulator for training medical practitioners includes a simulator model comprising one or more layers of simulated tissue. A plurality of pressure sensors are in communication with the one or more layers of simulated tissue and are configured to generate a pressure value sensed from one or more locations of the one or more layers of simulated tissue. A sensor system is in communication with the plurality of pressure sensors and is configured to receive the pressure values from one or more locations of the one or more layers of simulated tissue and to generate a risk value of developing a pressure ulcer for the one or more locations of the one or more layers of simulated tissue.

In some embodiments, the pressure ulcer simulator may be configured to simulate a physically impaired or unimpaired human body.

In some embodiments, the one or more layers of simulated tissue include simulated bone tissue and simulated soft tissue. The simulated soft tissue may include simulated muscle, fat and/or skin tissue. The simulated bone tissue and the simulated soft tissue may be formed of different materials having different mechanical properties such that a rigidity of the simulated bone tissue is higher than a rigidity of the simulated soft tissue. The pressure sensors may be positioned between simulated bone tissue and simulated soft tissue. The simulated bone tissue may include a greater trochanter simulation portion that is shaped and configured to simulate a greater trochanter of a femur, and at least one pressure sensor is positioned between the greater trochanter simulation portion of the simulated bone tissue and a portion of the simulated soft tissue adjacent the greater trochanter simulation portion of the simulated bone tissue.

In some embodiments, a pressure of greater than 32 kPa indicates an increased risk of developing a pressure ulcer, a pressure of greater than 27 kPa and less than 32 kPa indicates a moderately increased risk of developing a pressure ulcer, and a pressure of less than 27 kPa indicates a reduced risk of developing a pressure ulcer.

In some embodiments, the pressure ulcer simulator includes a user interface configured to display a risk level for a tissue region responsive to a sensed pressure level.

In some embodiments, at least one of the pressure sensors is positioned adjacent a portion of simulated tissue that is configured to simulate one or more of the following pressure ulcer risk sites: chin, iliac crest, knee, pre-tibial crest, occiput, scapula, spinous processes, sacrum, heel, ischium, iscial tuberosity, elbow, greater trochanter of a femur, and lateral malleolus.

In some embodiments, the plurality of pressure sensors include a piezoresistive force sensor and/or a catheter pressure transducer.

In some embodiments, methods for training a medical health practitioner include positioning a simulator model in a position. The simulator model includes one or more layers of simulated tissue and a plurality of pressure sensors in communication with the one or more layers of simulated tissue and configured to generate a pressure value sensed from one or more locations of the one or more layers of simulated tissue. The pressure values are received from one or more locations of the one or more layers of simulated tissue and a risk value of developing a pressure ulcer for the one or more locations of the one or more layers of simulated tissue is generated.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a pressure ulcer simulator system according to some embodiments of the present invention.

FIG. 2 is a digital image of a pressure ulcer simulator system according to some embodiments of the present invention.

FIG. 3 is a digital image of a case for a pressure ulcer simulator according to some embodiments of the present invention.

FIG. 4 is a digital image of a bone structure that may be embedded in a pressure ulcer simulator according to some embodiments of the present invention.

FIG. 5 is a digital image of a pressure ulcer simulator system according to some embodiments of the present invention.

FIG. 6 is side view of a pressure ulcer simulator system according to some embodiments of the present invention.

FIG. 7 is an exploded view of the knee portion of the pressure ulcer simulator system of FIG. 6.

FIG. 8 is an exploded view of the knee portions of the pressure ulcer simulator of FIG. 6.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

There are various degrees of pressure ulcers and symptoms associated with pressure ulcers. Pressure ulcers may cause injuries including changes in skin temperature, consistency or sensation; persistent redness, partial-thickness skin loss (similar to abrasion with a shallow crater or blister), full-thickness skin loss with subcutaneous tissue damage and a deep crater, and/or full-thickness skin loss with necrosis or damage to muscle bone or adjacent structures. Pressure ulcers may also be broadly considered either superficial or deep. The formation of pressure ulcers including superficial ulcers is predominantly due to shear stresses within the skin layers creating detachment and maceration of tissue. Other contributing factors are friction, moisture level and temperature. Typically, deeper tissue pressure ulcers may be formed by the degradation of muscle tissue over a bony prominence due to sustained mechanical loading (i.e., compression). With deeper tissue pressure ulcers, the injury develops under the intact skin; thus, the damage may be difficult to detect at early stages. Deeper tissue pressure ulcers may progress at a more rapid rate than superficial ulcers and can lead to extensive damage as the ulceration advances toward the skin surface.

Pressure ulcers have been defined and/or classified by the National Pressure Ulcer Advisory Panel (NPUAP). It should be understood, however, that definitions of pressure ulcers and associated staging or classification criteria may be modified without departing from the scope of the invention. Pursuant to revisions by NPUAP in 2007, a pressure ulcer is generally defined as a localized injury to the skin and/or underlying tissue usually over a bony prominence, as a result of pressure, or pressure in combination with shear and/or friction. A number of contributing or confounding factors may also be associated with pressure ulcers. The NPUAP defines pressure ulcer stages as follows:
Suspected Deep Tissue Injury: Purple or maroon localized area of discolored intact skin or blood-filled blister due to damage of underlying soft tissue from pressure and/or shear. The area may be preceded by tissue that is painful, firm, mushy, boggy, warmer or cooler as compared to adjacent tissue. Deep tissue injury may be difficult to detect in individuals with dark skin tones. Evolution may include a thin blister over a dark wound bed. The wound may further evolve and become covered by thin eschar. Evolution may be rapid exposing additional layers of tissue even with optimal treatment.
Stage I: Intact skin with non-blanchable redness of a localized area usually over a bony prominence. Darkly pigmented skin may not have visible blanching; its color may differ from the surrounding area. The area may be painful, firm, soft, warmer or cooler as compared to adjacent tissue. Stage I may be difficult to detect in individuals with dark skin tones and may indicate persons “at risk.”
Stage II: Partial thickness loss of dermis presenting as a shallow open ulcer with a red pink wound bed, without slough. May also present as an intact or open/ruptured serum-filled blister. Presents as a shiny or dry shallow ulcer without slough or bruising (bruising indicates suspected deep tissue injury). This stage should not be used to describe skin tears, tape burns, perineal dermatitis, maceration or excoriation.
Stage III: Full thickness tissue loss. Subcutaneous fat may be visible but bone, tendon or muscle are not exposed. Slough may be present but does not obscure the depth of tissue loss. May include undermining and tunneling. The depth of a stage III pressure ulcer varies by anatomical location. The bridge of the nose, ear, occiput and malleolus do not have subcutaneous tissue and stage III ulcers can be shallow. In contrast, areas of significant adiposity can develop extremely deep stage III pressure ulcers. Bone/tendon is not visible or directly palpable.
Stage IV: Full thickness tissue loss with exposed bone, tendon or muscle. Slough or eschar may be present on some parts of the wound bed. Often include undermining and tunneling. The depth of a stage IV pressure ulcer varies by anatomical location. The bridge of the nose, ear, occiput and malleolus do not have subcutaneous tissue and these ulcers can be shallow. Stage IV ulcers can extend into muscle and/or supporting structures (e.g., fascia, tendon or joint capsule) making osteomyelitis possible. Exposed bone/tendon is visible or directly palpable.
Unstageable: Full thickness tissue loss in which the base of the ulcer is covered by slough (yellow, tan, gray, green or brown) and/or eschar (tan, brown or black) in the wound bed. Until enough slough and/or eschar is removed to expose the base of the wound, the true depth, and therefore stage, cannot be determined. Stable (dry, adherent, intact without erythema or fluctuance) eschar on the heels serves as “the body's natural (biological) cover” and should not be removed.

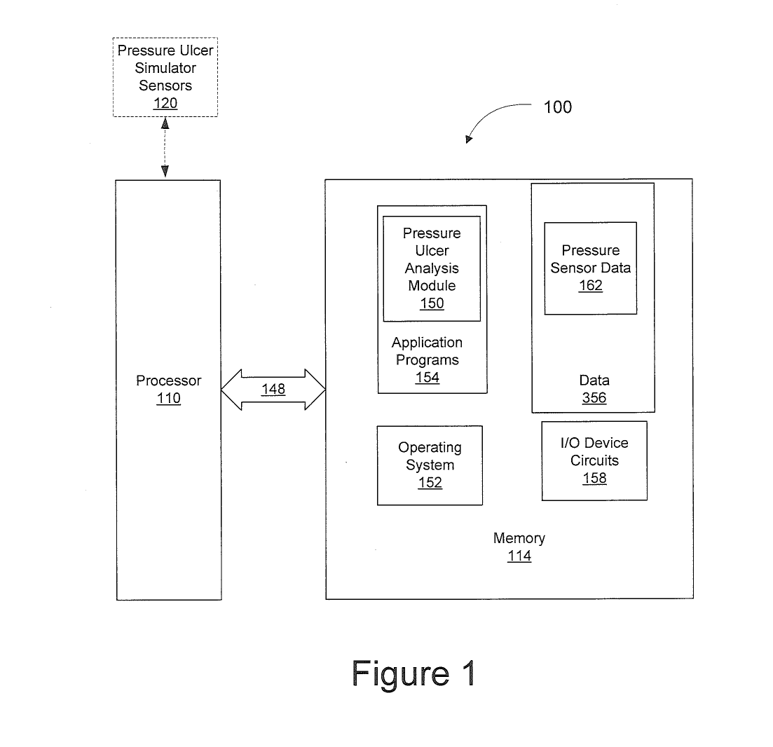

FIG. 1 is a block diagram of exemplary embodiments of data processing systems that illustrates systems, methods, and computer program products in accordance with embodiments of the present invention. As shown in FIG. 1, a data processing system 100 includes a processor 110, and is in communication with pressure ulcer simulator 120. The pressure ulcer simulator 120 can include a patient simulator having simulated tissue and pressure sensors in and/or on the tissue. The pressure sensors of the pressure ulcer simulator 120 may communicate pressure readings to the processor 110 to generate a likelihood of developing a pressure ulcer responsive to the sensed pressure at various locations in the tissue.

The processor 110 communicates with the memory 114 via an address/data bus 148. The processor 110 can be any commercially available or custom microprocessor. The memory 114 is representative of the overall hierarchy of memory devices containing the software and data used to implement the functionality of the data processing system 100. The memory 114 can include, but is not limited to, the following types of devices: cache, ROM, PROM, EPROM, EEPROM, flash memory, SRAM, and DRAM.

As shown in FIG. 1, the memory 114 may include several categories of software and data used in the data processing system 100: the operating system 152; the application programs 154; the input/output (I/O) device drivers 158; a pressure ulcer analysis module 150 and the data 156. The data 156 may include pressure sensor data 150 (which can include electrical signals from the pressure ulcer simulator 120).

As will be appreciated by those of skill in the art, the operating system 152 may be any operating system suitable for use with a data processing system, such as OS/2, AIX, OS/390 or System390 from International Business Machines Corporation, Armonk, N.Y., Windows CE, Windows NT, Windows2003 and Windows 2007 from Microsoft Corporation, Redmond, Wash., Unix or Linux or FreeBSD, Palm OS from Palm, Inc., Mac OS from Apple Computer, or proprietary operating systems. The I/O device drivers 158 typically include software routines accessed through the operating system 152 by the application programs 154 to communicate with devices such as I/O data port(s), data storage 156 and certain memory 114 components and/or the pressure ulcer simulator 120. The application programs 154 are illustrative of the programs that implement the various features of the data processing system 100 and can include at least one application which supports operations according to embodiments of the present invention. Finally, the data 156 represents the static and dynamic data used by the application programs 154, the operating system 152, the I/O device drivers 158, and other software programs that may reside in the memory 114.

The pressure ulcer analysis module 150 can be configured to perform operations according to embodiments of the present invention. For example, the pressure ulcer analysis module 150 can be configured to control the pressure ulcer simulator 120 and/or to obtain data from the pressure ulcer simulator 120. In particular embodiments, the pressure ulcer analysis module 150 includes pressure sensors configured to generate a pressure signal indicating a pressure or force at various locations in a patient simulator. The pressure ulcer analysis module 150 can be configured to process sensor data, such as pressure sensor data from the pressure ulcer simulator sensors, to determine a risk of pressure ulcers using the techniques described herein.

While the present invention is illustrated, for example, with reference to the pressure ulcer analysis module 150 being an application program in FIG. 1, as will be appreciated by those of skill in the art, other configurations may also be utilized while still benefiting from the teachings of the present invention. For example, the pressure ulcer analysis module 150 may also be incorporated into the operating system 152, the I/O device drivers 158 or other such logical division of the data processing system 100. Thus, the present invention should not be construed as limited to the configuration of FIG. 1, which is intended to encompass any configuration capable of carrying out the operations described herein.

The I/O data port can be used to transfer information between the data processing system 100 and the pressure ulcer simulator 120 or another computer system or a network (e.g., the Internet) or to other devices controlled by the processor. These components may be conventional components such as those used in many conventional data processing systems that may be configured in accordance with the present invention to operate as described herein. Therefore, the pressure ulcer analysis module 150 can be used to analyze pressure sensor data 162 that has been previously collect and/or pressure sensor data 162 that is collected from the pressure ulcer simulator 120.

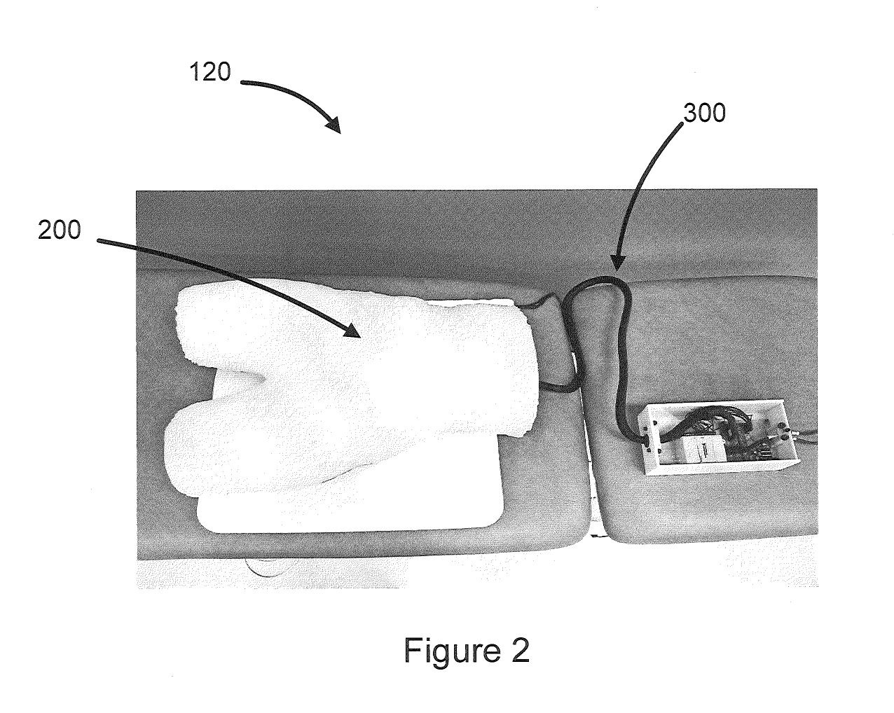

As illustrated in FIG. 2, the pressure ulcer simulator 120 includes a patient simulator model 200 that includes one or more layers of simulated tissue and a cable 300 that is in communication with pressure sensors (not shown) in the model 200 and is configured to transmit pressure sensor signals to a pressure ulcer analyzer. As illustrated, the patient simulator model 200 includes the pelvis/hip region. However, it should be understood that other portions of the body or a full body model may be used. The patient simulator model 200 includes various layers of simulated tissue, such as simulated bone tissue and simulated soft tissue (including simulated muscle, fat and/or skin tissue). The simulated bone tissue has a rigidity that is higher that the rigidity of the simulated soft tissue. For example, various types of silicone having different formulations and/or mechanical properties may be used. In particular, Ecoflex 00-30 (Smooth-On, Inc., Easton, Pa., U.S.A.) may be used to simulate skin tissue, Ecoflex 00-10 (Smooth-On, Inc., Easton, Pa., U.S.A.) may be used to simulate fat tissue, and Dragon Skinn 10 (Smooth-On, Inc., Easton, Pa., U.S.A.) may be used to simulate muscle tissue.

In some embodiments, the instantaneous shear moduli of the simulated tissue is as follows:

a. Simulated muscle tissue shear modulus: 4-16 kPa, 3-20 kPa, 2-50 kPa, 1-100 kPa (4-16 kPa is preferable)

b. Simulated fat tissue shear modulus: 12-32 kPa, 10-50 kPa, 5-75 kPa, 1-100 kPa (12-32 kPa is preferable)

c. Simulated skin tissue shear modulus: 2-32 kPa, 2-60 kPa, 2-80 kPa, 1-100 kPa (2-32 kPa is preferable)

d. Simulated bone tissue shear modulus: rigid (shear modulus of 100 to 200 MegaPascals)

In some embodiments, the Young's modulus of the simulated tissue is as follows:

a. Muscle Young's modulus: 10-45 kPa, 5-100 kPa, 1-300 kPa

b. Fat Young's modulus: 32-86 kPa, 15-100 kPa, 5-200 kPa

c. Skin Young's modulus: 5-86 kPa, 5-100 kPa, 5-200 kPa

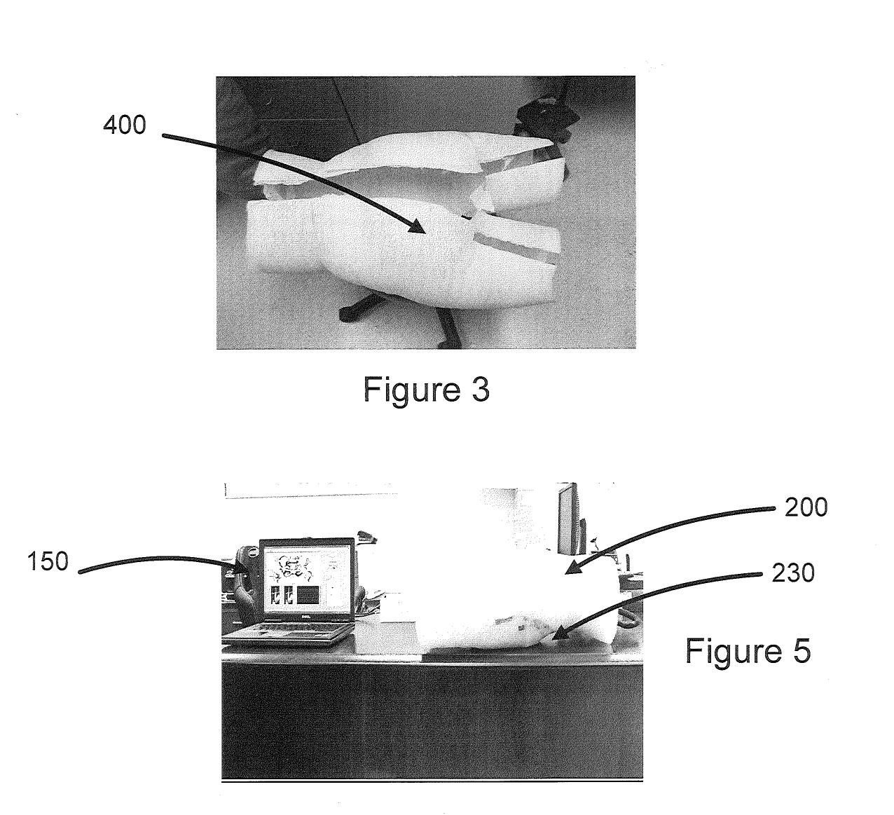

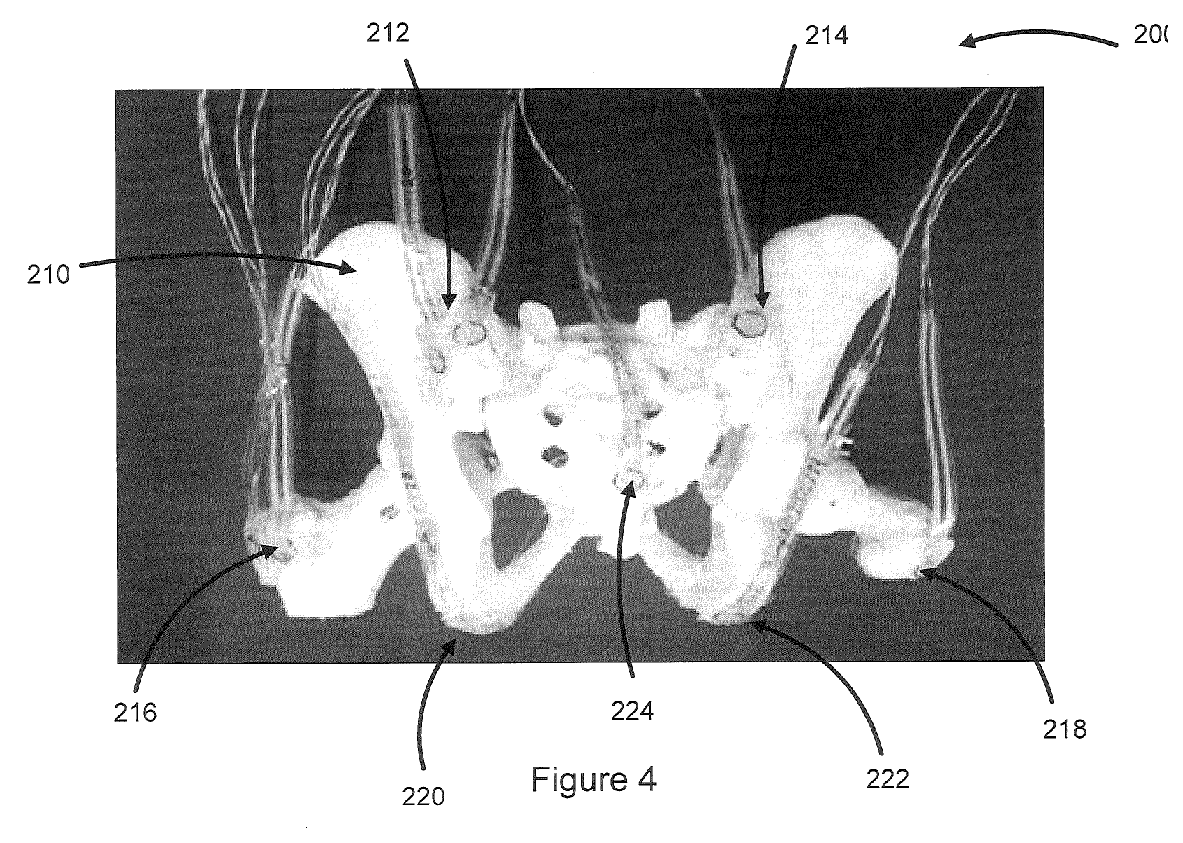

For example, as illustrated in FIG. 3, a fiberglass cast 400 of the pelvis/hip region may be used to form the simulator model 200. As illustrated in FIG. 4, a simulated pelvic bone 210 may be used, and pressure sensors may be affixed to the pelvic bone 210. As illustrated, the pressure sensors include one or more sensors at the following locations: posterior superior iliac spine sensors 212, 214, greater trochanter of the femur sensors 216, 218, ischial tubersosity sensors 220, 222 and a median sacral crest sensor 224. The pelvic bone 210 and other simulated bone tissues may be suspended in the fiberglass cast 400 of FIG. 3 in approximate anatomical positions, and one or more types of silicone may be cast around the bone tissues. As illustrated in FIG. 5, the resulting simulator model 200 may have additional pressure sensors 230 embedded in layers of simulated tissue, which are in communication with the pressure ulcer analysis module 150 on a computer. The pressure sensors may be any suitable pressure sensor, including thin film or piezoresistive force sensors, such as Flexiforce™ sensors (Tekscan, Inc., South Boston, Mass., U.S.A.), multi-axis force sensors, such as BL NANO Sensor (6-axis Force/Torque Fingertip Type Sensor from BL Autotec, LTD (Kobe, Japan), or shear sensors, such as piezoresistive shear sensors, e.g., Tactilus® (Sensor Products, Inc. (Madison, N.J., U.S.A).

In some embodiments, a catheter pressure transducer, such as a Millar Mikro-Tip® catheter pressure transducer (Milar Instruments, Inc., Houston, Tex., U.S.A) may be used. For example, the Millar Micro-Tip® catheter pressure transducer or an analogous transducer may be inserted via an insertion needle into the cast simulator model, such as into a layer of silicone or other material in the model 200. Accordingly, the pressure transducers may be inserted after formation of the model 200 (including simulated layers of bone and/or soft tissue). In some embodiments, the transducers may be coated or enclosed with a gelatinous substance during insertion to increase contact with the simulated tissue layers. The transducers may also be removable, and in some embodiments, the transducers may be removed and/or replaced, e.g., so that the transducers may be periodically calibrated.

In some embodiments, the pressure sensors may be embedded in one or more of the layers of simulated tissue and/or positioned between different layers of tissue. For example, shear sensors may be positioned between different layers of soft tissue (e.g., simulated fat, muscle or skin tissue) or between a simulated bone tissue and a layer of simulated soft tissue. The pressure sensors may be configured to detect normal force, multi-axis force and/or shear stress. In some embodiments, the pressure sensors are placed adjacent bony protuberances as described herein.

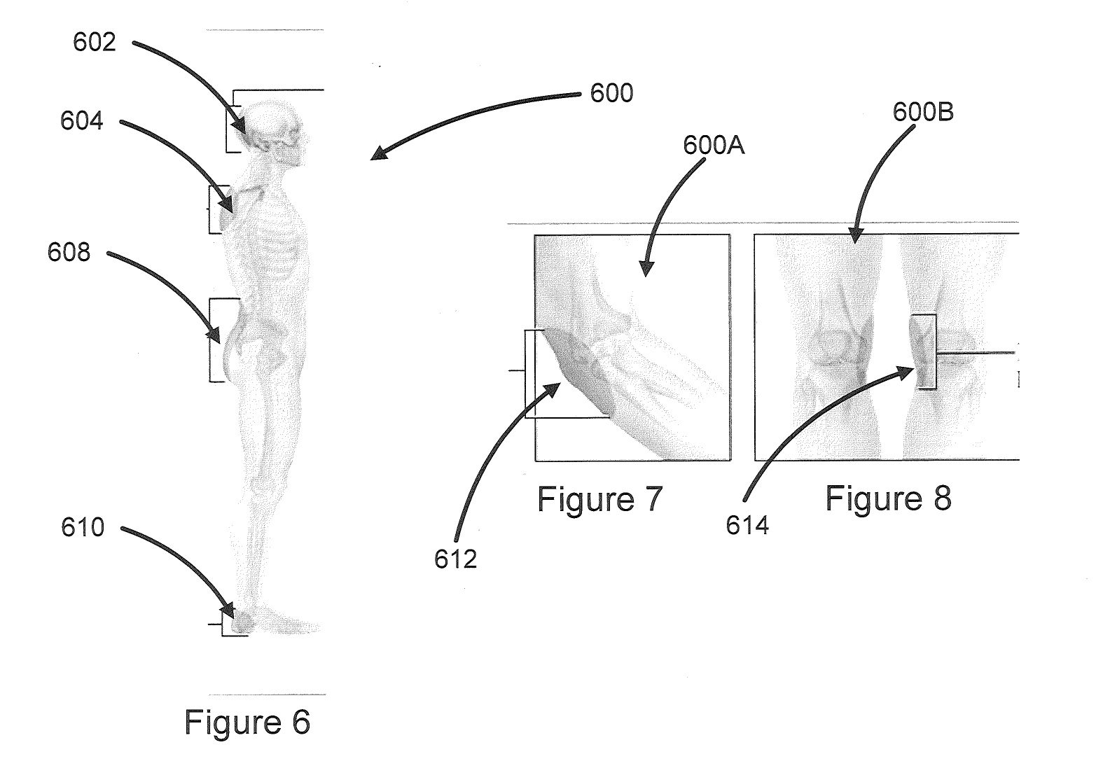

Although embodiments according to the invention are described herein with respect to a partial or torso model 200, it should be understood that other partial (e.g., missing body portions, such as the arms, head or other extremeties) or whole body models may be used. For example, a full or near full body model 600 is shown in FIGS. 6-8. As illustrated, pressure sensors as described herein may be positioned in the occiput region 602, the scapula region 604, the sacrum, coccyx, and/or ischium region 608, the calcaneus region 610. As illustrated with respect to the model portions 600A, 600B in FIGS. 7 and 8, pressure sensors may also be positioned in the front knee region 612 and/or the interior knee region 614. Thus, pressure sensors may be positioned in various locations of a patient simulator model according to embodiments of the present invention, such as adjacent a portion of simulated tissue that is configured to simulate one or more of the following pressure ulcer risk sites: chin, mucosal margins of mouth and anus and area to the side of nose and posterior ear (which may be at risk for pressure ulcers caused by patient device related pressure wounds due to tubes, catheters or other inserted devices), occiput, iliac crest, anterior superior iliac spine, patella, lateral and medial knee, pre-tibial crest, scapula, spinous processes, sacrum, coccyx, heel, ischial tuberosity, elbow (olecranon and medial and lateral region), greater trochanter of a femur, medial malleolus, lateral malleolus, posterior heel, tips of toes, metatarsal heads and lateral foot. Patient simulator models may be provided that include sensors in the following locations to detect risks of pressure ulcer formation in the following corresponding positions:

| | |
|---|---|
| Prone | Chin, iliac crest, knee, pre-tibial crest, anterior superior iliac |
| position | spine, patella, tips of toes |
| Supine | Occiput, scapula amd scapular spine, spinous processes, |
| position | sacrum, coccyx, heel, olecranon (elbow), tips of toes |
| Sitting | Ischium (e.g. iscial tuberosity), posterior elbow, bottom of the |
| position | heel, posterior heel, spine of scapula, spinous processes, |
| | occiput, sacrum, coccyx, bottom or inferior heel, metatarsal |
| | heads, tips of toes |
| Lateral | Greater trochanter of femur, lateral and medial malleolus, lateral |
| position | and medial knee, lateral elbow, parietal region of the skull, |
| | lateral foot, iliac crest |

Accordingly, pressure sensors may be embedded adjacent bone simulated tissue and in simulated soft tissue to detect pressure readings indicating a risk of pressure ulcer formation. In some embodiments, the range of pressure that may be detected (where lower pressures generally indicate a reduced risk of pressure ulcer formation for a given period of time) may be as follows:

a. Simulated muscle tissue: 20-53 kPa, 10-100 kPa, 5-500 kPa (a broader measurement range would allow for the possibility to simulate a wider range of subject conditions (obesity, disease, etc))

b. Simulated fat tissue: 14-24 kPa, 10-100 kPa, 5-500 kPa

c. Simulated skin tissue: 14-24 kPa, 10-100 kPa, 5-500 kPa

For example, for less than one hour of exposure to pressure, pressures >32 kPa may be associated with tissue damage, pressures <27 kPa may not be associated with tissue damage, and the range of pressures between 27 and 32 kPa may be classified as a region of uncertainty. Linder-Ganz, E., Engelberg, S., Scheinowitz, M., Gefen, A., 2006. Pressure-time cell death threshold for albino rat skeletal muscles as related to pressure sore biomechanics. Journal of Biomechanics 39, 2725-2732. It should be understood that these values may vary based on various factors, such as the age, health or hydration of the patient.

In some embodiments, shear stresses of tissue may also be detected (where less shear stress generally indicates a reduced risk of pressure ulcer formation for a given period of time). Exemplary shear stress values that may be detected according to some embodiments are as follows:

a. Simulated muscle tissue: 12-30 kPa, 10-100 kPa, 5-500 kPa

b. Simulated fat tissue: 7-13 kPa, 5-100 kPa, 1-500 kPa

c. Simulated skin tissue: 7-13 kPa, 5-100 kPa, 1-500 kPa

Therefore, medical health practitioners may be trained using pressure ulcer simulators according to some embodiments of the present invention. For example, after a practitioner positions a patient simulator model in a desired position (e.g., in a bed or wheel chair) the pressure values discussed above may be used in a software interface, so that pressure readings in the “high risk” range (>32 kPa) could light up in red, for example, and pressure readings in the moderate risk range (27-32 kPa) could light up in yellow, and pressure readings in the low risk range (<27 kPa) could light up in green. This feedback may serve as a training aid for the user, e.g., to indicate when a particular position places certain tissues at high risk for pressure ulcer development.

Patient simulator models according to some embodiments may be adjusted to simulate a particular patient profile, such as a degree of health, age, hydration value, weight etc. Pressure ulcer simulator models may be adjusted to simulate different patient profiles by adjusting the size and/or configuration of the simulated tissue and/or placement/selection of sensors. In some embodiments, pressure values that indicate risk may be adjusted to account for different patient profiles.

In some embodiments, patient simulator models may include functional joints such that medical health practitioners may move the simulator model, e.g., at a hip joint to move from a reclining to a sitting position or vice versa. In some embodiments, a pressure ulcer simulation element may be used to simulate damage tissue on the patient simulator model with materials that simulate the look and feel of fluid oozing from a pressure ulcer. The pressure ulcer simulation element may also be configured to “heal” in response to treatment provided by training medical health practitioners.

A patient pressure ulcer simulator according to some embodiments may be used to evaluate the efficacy of commercial products, such as personal care and therapeutic interventions for pressure relief or redistribution. For example, patient pressure ulcer simulators may be used to evaluate the efficacy of existing or new products in development to determine if the pressure may be decreased in at risk tissues, e.g., adjacent to bony proturberances. Various products, including protective clothing, wound dressings, therapeutic surfaces for beds, wheel chairs, chairs or positioning devices may be evaluated by patient pressure ulcer simulators according to some embodiments. Patient pressure ulcer simulators according to some embodiments may be used for product formulatory design or custom design of pressure relieving and/or redistribution positioning aids or devices. Therapeutic medical products and non-therapeutic products, such as chairs, car seats, mattresses, cushions and airline seats, may be evaluated according to some embodiments of the present invention.

In some embodiments, the pressure ulcer simulator may be configured to simulate a physically impaired or unimpaired human body or a portion thereof, e.g., by being shaped to conform to typical human shapes of physical impairment or unimpairment. Various simulators may be used, for example, to simulate patients of various heights, weights (normal, obese, overly thin, etc.) or ages. Such simulators may be used for product formulatory design or custom design or for patient treatment training as described herein.

In some embodiments, manuals may be provided to assist users in evaluating pressure readings, positioning simulators, etc. A user interface may provide feedback to the user regarding detected stress or pressure levels. For example, a means for indicating the detected risk of developing a pressure ulcer may include a graphic or text display, an audio warning (verbal or tone), color coded lights (green for low risk, yellow for intermediate or moderate risk, and red for high risk), etc.

Embodiments according to the present invention will now be described with respect to the following non-limiting example.

### Example 1

A mold was created from a fiberglass cast from waist to mid-thigh (FIG. 3). The inside of the mold was “painted” with a thin layer of the skin simulant material. Next, an anatomical model of the pelvis was instrumented with pressure sensors at selected bony prominences (selected sites are associated clinically with high risk for pressure ulcer development) (FIG. 4). Simulated muscles were then created by pouring muscle simulant material into separate molds that were previously constructed to mimic the approximate shape of the major muscles of the pelvis and hip region. The muscles were then affixed to the instrumented bony pelvis in the correct anatomical locations (approximate). Sensors were then affixed to the outside of the muscles where appropriate (over the selected bony prominence sites). The bony pelvis with attached muscles was then suspended inside the fiberglass mold in the correct anatomical location (approximate). Pressure sensors were affixed to the skin layer (lining the fiberglass mold) over the selected bony prominence sites. Simulated fat material (in liquid form) was then poured into the mold, to fill the spaces between the skin layer and the muscles. The fat material was then allowed to solidify.

### Example 2

Simulated tissue may be tested to compare mechanical properties with those of actual tissue. Uniaxial compression tests were performed on three formulations of silicone rubbers and were compared to literature values of material properties for muscle, skin, and fat. The three types of silicone rubbers were DragonSkin to represent muscle, EcoFlex 0030 to represent skin, and EcoFlex 0010 to represent fat. The samples were prepared as cylinders (diameter 35.8 mm and height 24.5 mm) by pouring the liquid form of the silicone into a mold and allowing it to cure for the recommended amount of time. Six of each type of rubber was made and then tested in uniaxial compression using the Bose Electroforce LM1 Testbench compression device with a Bose load cell attached that has a 250N capacity. The top and bottom surfaces of each sample were coated in petroleum jelly to reduce the effects of friction.

The compression tests were performed at a strain rate of 1% s⁻¹ to a 25% maximum strain and held for 5 minutes. The loading phase of the data was then averaged and a model was matched to this using the two-term polynomial procedure in Abaqus (Abaqus 6.10.1, Simulia Corp.) with the energy function:

$$U = {\sum }_{i + j = 1}^{N} {{C}_{ij} ( {I}_{1} - 3 )}^{i} {( {I}_{2} - 3 )}^{j} + {\sum }_{i = 1}^{N} \frac{1}{{D}_{i}} {( {J}_{el} - 1 )}^{2 i} , \qquad ( 1 )$$

where Cᵢⱼ and Dᵢ are material parameters, I₁ and I₂ are the first and second invariants, respectively, and Jₑ₁ is the elastic volume strain (ABAQUS: ABAQUS User's Manual (Version 6.10). Providence, Dassault Systemes Simulia Corp., 2010). In the case of the two-term function N=2. From the values of these material parameters, the instantaneous shear modulus μ₀ and the bulk modulus k₀ were determined as follows:

$$\begin{matrix}{μ}_{0} = 2 ( {C}_{10} \vert {C}_{01} ) , & ( 2 ) \\ {k}_{0} - \frac{2}{{D}_{1}} . & ( 3 )\end{matrix}$$

The initial Young's modulus was then found using these two values as such:

$${E}_{0} = \frac{9 {k}_{0} {μ}_{0}}{3 {k}_{0} + {μ}_{0}} .$$

Statistical Analysis

The stress-strain curves for the data were compared to those of the model using a correlation coefficient.

Results:

The correlation coefficients of the models of DragonSkin, EcoFlex0010, and EcoFlex0030 to the data from each were all above 0.99 showing an almost perfect fit of the models to the data for each. This result gives confidence in the shear modulus values discerned from the model.

Table 1 shows a summary of the instantaneous shear modulus values of the silicone rubbers and a range of values for actual muscle, fat, and skin tissues found in the literature (for tissues tested in compression). From Table 1, DragonSkin had an instantaneous shear modulus of 85.9 kPa, EcoFlex0010 a modulus of 21.1 kPa, and EcoFlex0030 a modulus of 32.4 kPa.

TABLE 1

| | | Instantaneous Shear Modulus, |
|---|---|---|
| | | μ₀ (kPa) |
| Muscle | Actual Tissue | 4.6-15.6^{1,2,3} |
| | DragonSkin | 85.9 |
| Fat | Actual Tissue | 12-31.9^{1,4} |
| | EcoFlex0010 | 21.1 |
| Skin | Actual Tissue | 2.8-31.9^{1,5} |
| | EcoFlex0030 | 32.4 |

Discussion:

For silicone rubbers, there is a general agreement between the EcoFlex0010 and fat and the EcoFlex0030 and skin. EcoFlex0010 is in the middle of the range of instantaneous shear modulus values found for adipose tissue in the literature. Ecoflex0030 is just past the upper end of the range for instantaneous shear modulus values found in the literature for skin. In stark contrast to these two matches, however, is the mismatch of the DragonSkin instantaneous shear modulus to the values found for muscle. The upper end of the range for muscle is 15.6 kPa and the value found for DragonSkin was 85.9 kPa. Other silicone formulations may be selected to better match the shear modulus for muscle.

### REFERENCES

1. Linder-Ganz E, Shabshin N, Itzchak Y, and Gefen A: Assessment of mechanical conditions in sub-dermal tissues during sitting: A combined experimental-MRI and finite element approach. J Biomech 2007; 40: 1443-1454
2. Bosboom E, Hesselink M, Oomens C, Bouten C, Drost M, Baaijens F: Passive transverse mechanical properties of skeletal muscle under in vivo compression. J Biomech 2001; 34: 1365-1368
3. Van Loocke M, Lyons C G, Simms C K: Viscoelastic properties of passive skeletal muscle in compression: stress-relaxation behaviour and constitutive modeling. J Biomech 2008; 41:1555-66.
4. Weaver J B, Doyley M, Cheung Y, Kennedy F, Madsen E L, Van Houten E E, Paulson K. Imaging the shear modulus of the heel fat pads. Clin Biomech 2005; 20(3): 312-9.
5. Zahouani H, Pailler-Mattei C, Sohm B, Vargiolu R, Cenizo V, Debret R. Characterization of the mechanical properties of a dermal equivalent compared with human skin in vivo by indentation and static friction tests. Skin Res Technol 2009; 15(1): 68-76.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A pressure ulcer simulator for training medical practitioners comprising:
a simulator model comprising one or more layers of simulated tissue and a plurality of pressure sensors in communication with the one or more layers of simulated tissue and configured to generate a pressure value sensed from one or more locations of the one or more layers of simulated tissue; and
a sensor system in communication with the plurality of pressure sensors and configured to receive the pressure values from one or more locations of the one or more layers of simulated tissue and to generate a risk value of developing a pressure ulcer for the one or more locations of the one or more layers of simulated tissue.

2. The pressure ulcer simulator of claim 1, wherein the one or more layers of simulated tissue comprise simulated bone tissue and simulated soft tissue.

3. The pressure ulcer simulator of claim 2, wherein the simulated soft tissue further comprises simulated muscle, fat and/or skin tissue.

4. The pressure ulcer simulator of claim 2, wherein the simulated bone tissue and the simulated soft tissue are formed of different materials having different mechanical properties such that a rigidity of the simulated bone tissue is higher than a rigidity of the simulated soft tissue.

5. The pressure ulcer simulator of claim 4, wherein the pressure sensors are positioned between simulated bone tissue and simulated soft tissue.

6. The pressure ulcer simulator of claim 5, wherein the simulated bone tissue comprises a greater trochanter simulation portion that is shaped and configured to simulate a greater trochanter of a femur, and at least one pressure sensor is positioned between the greater trochanter simulation portion of the simulated bone tissue and a portion of the simulated soft tissue adjacent the greater trochanter simulation portion of the simulated bone tissue.

7. The pressure ulcer simulator of claim 1, further comprising a means for indicating at a pressure of greater than about 32 kPa an increased risk of developing a pressure ulcer.

8. The pressure ulcer simulator of claim 7, further comprising a means for indicating at a pressure of greater than about 27 kPa and less than about 32 kPa a moderately increased risk of developing a pressure ulcer.

9. The pressure ulcer simulator of claim 8, further comprising a means for indicating at a pressure of less than about 27 kPa a reduced risk of developing a pressure ulcer.

10. The pressure ulcer simulator of claim 1, further comprising a user interface configured to display a risk level for a tissue region responsive to a sensed pressure level.

11. The pressure ulcer simulator of claim 1, wherein at least one of the pressure sensors are positioned adjacent a portion of simulated tissue that is configured to simulate one or more of the following pressure ulcer risk sites: chin, iliac crest, knee, pre-tibial crest, occiput, scapula, spinous processes, sacrum, heel, ischium, iscial tuberosity, elbow, greater trochanter of a femur, and lateral malleolus.

12. The pressure ulcer simulator of claim 1, wherein the plurality of pressure sensors comprises a piezoresistive force sensor.

13. The pressure ulcer simulator of claim 1, wherein the plurality of pressure sensors comprises a catheter pressure transducer.

14. A method for training a medical health practitioner, the method comprising:
positioning a simulator model in a position, the simulator model comprising one or more layers of simulated tissue and a plurality of pressure sensors in communication with the one or more layers of simulated tissue and configured to generate a pressure value sensed from one or more locations of the one or more layers of simulated tissue;
receiving the pressure values from one or more locations of the one or more layers of simulated tissue; and
generating a risk value of developing a pressure ulcer for the one or more locations of the one or more layers of simulated tissue.

15. The method of claim 14, further comprising indicating an increased risk of developing a pressure ulcer at a detected pressure value of greater than about 32 kPa.

16. The method of claim 14, further comprising indicating a moderate risk of developing a pressure ulcer at a detected pressure value of greater than about 27 kPa and less than about 32 kPa.

17. The method of claim 14, further comprising indicating a reduced risk of developing a pressure ulcer at a detected pressure value of less than about 27 kPa.
